(19) United States
(12) Patent Application Publication
(10) Pub. No.: US 2009/0046985 A1
(43) Pub. Date: Feb. 19, 2009

(54) Fiber Optic Enclosure Internal Cable Management

(76) Inventors: Erik Gronvall, Richfield, MN (US); Claudia Ivonne Corral, Savage, MN (US)

Correspondence Address: MERCHANT & GOULD PC, P.O. BOX 2903, MINNEAPOLIS, MN, 55402-0903, US

(21) Appl. No.: 11/839,695

(22) Filed: Aug. 16, 2007

(51) Int. Cl. G02B 6/00

(52) U.S. Cl. 385/135

(57) ABSTRACT

A fiber access terminal assembly includes a front housing piece with an exterior side and an interior side having a slack storage area and a rear housing piece mounted to the interior side of the front housing piece. A bend radius limiter having a retention portion with a first end and an oppositely disposed second end, a radius limiting portion disposed at the first end, and a side portion disposed at the second end is mounted in the slack storage area. The retention portion, the radius limiting portion, and the side portion cooperatively define a passageway for optical fiber routing. A method of routing cable in the fiber access terminal includes providing a fiber access terminal assembly, inserting cable through a cable entry in the housing, routing optical fibers of the cable loosely through the passageway, and connecting ends of the optical fiber to fiber optic adapters.

### TECHNICAL FIELD

The present disclosure relates generally to fiber access terminals housing optical fiber connections, and more particularly, to fiber access terminals providing cable management with bend radius protection.

### BACKGROUND

Fiber optic cables are widely used to transmit light signals for high speed data transmission. A fiber optic cable typically includes: (1) an optical fiber or optical fibers; (2) a buffer or buffers that surrounds the fiber or fibers; (3) a strength layer that surrounds the buffer or buffers; and (4) an outer jacket. Optical fibers function to carry optical signals. A typical optical fiber includes an inner core surrounded by a cladding that is covered by a coating. Buffers (e.g., loose or tight buffer tubes) typically function to surround and protect coated optical fibers. Strength layers add mechanical strength to fiber optic cables to protect the internal optical fibers against stresses applied to the cables during installation and thereafter. Example strength layers include aramid yarn, steel and epoxy reinforced glass roving. Outer jackets provide protection against damage caused by crushing, abrasions, and other physical damage. Outer jackets also provide protection against chemical damage (e.g., ozone, alkali, acids).

Fiber optic cable connection systems are used to facilitate connecting and disconnecting fiber optic cables in the field without requiring a splice. A typical fiber optic cable connection system for interconnecting two fiber optic cables includes fiber optic connectors mounted at the ends of the fiber optic cables, and an adapter for mechanically and optically coupling the fiber optic connectors together. Fiber optic connectors generally include ferrules that support the ends of the optical fibers of the fiber optic cables. The end faces of the ferrules are typically polished and are often angled. The adapter includes co-axially aligned ports (i.e., receptacles) for receiving the fiber optic connectors desired to be interconnected. The adapter includes an internal sleeve that receives and aligns the ferrules of the fiber optic connectors when the connectors are inserted within the ports of the adapter. With the ferrules and their associated fibers aligned within the sleeve of the adapter, a fiber optic signal can pass from one fiber to the next. The adapter also typically has a mechanical fastening arrangement (e.g., a snap-fit arrangement) for mechanically retaining the fiber optic connectors within the adapter. One example of an existing fiber optic connection system is described in U.S. Pat. Nos. 6,579,014, 6,648,520, and 6,899,467.

Fiber optic telecommunication technology is becoming prevalent in part because service providers want to deliver high bandwidth communication capabilities to subscribers. One such technology is referred to as passive optical networks (PONS). PONS may use optical fibers deployed between a service provider central office, or head end, and one or more end user premises. A service provider may employ a central office, or head end, containing electronic equipment for placing signals onto optical fibers running to user premises. End user premises may employ equipment for receiving optical signals from the optical fibers. In PONS, the central office, or head end, transmission equipment and/or the transmission equipment located at the end user premises may, respectively, use a laser to inject data onto a fiber in a manner that may not require the use of any active components, such as amplifiers between the central office, or head end, and/or the end user premises. In other words, only passive optical components, such as splitters, optical fibers, connectors and/or splices, may be used between a service provider and an end user premises in PONS. PONS may be attractive to service providers because passive networks may be less costly to maintain and/or operate as compared to active optical networks and/or older copper based networks, such as a public switched telephone network (PSTN). In addition to possibly being less expensive than other network topologies, PONS may provide sufficient bandwidth to meet a majority of end users' high bandwidth communication needs into the foreseeable future.

In PONS, transmission equipment may transmit signals containing voice, data and/or video over a fiber strand to the premises. An optical fiber may be split using, for example, passive optical splitters so that signals are dispersed from one fiber (the input fiber) to multiple output fibers running to, for example, user premises from a convergence point in the network. An optical fiber routed to a user's premises may be routed via a fiber drop terminal en route to the premises. At the fiber drop terminal, signals appearing on one or more optical fibers may be routed to one or more end user premises. Fiber drop terminals may be mounted in aerial applications, such as near the tops of utility poles, along multi-fiber and/or multi-conductor copper strands suspended between utility poles. Fiber drop terminals may also be installed in junction boxes mounted at ground level and/or in below-grade vaults where utilities are run below ground. Example fiber drop terminals are disclosed at U.S. Pat. No. 7,120,347; U.S. Patent Publication No. US 2005/0213921; and U.S. Patent Publication No. US 2006/0153517.

### SUMMARY

An aspect of the present disclosure relates to a fiber access terminal assembly having a housing that includes a front housing piece and a rear housing piece, with the front housing piece having an interior side and an exterior side and the rear housing piece being selectively mounted to the front housing piece. A slack storage area is defined by the interior side of the front housing piece. At least one bend radius is mounted to the slack storage area of the front housing piece. The bend radius limiter has a retention portion with a first end and an oppositely disposed second end, a radius limiting portion disposed at the first end of the retention portion, and a side portion disposed at the second end of the retention portion. The retention portion, the radius limiting portion, and the side portion cooperatively define a passageway for optical fiber routing.

Another aspect of the present disclosure relates to a method of routing cable through a fiber access terminal. The method includes the steps providing a fiber access terminal having a housing that includes a front housing piece and a rear housing piece. The front housing piece has an interior side and an exterior side. The rear housing piece is selectively mounted to the interior side of the front housing piece. A slack storage area is defined by the interior side of the front housing piece At least one bend radius is mounted to the slack storage area of the front housing piece. The bend radius limiter has a retention portion with a first end and an oppositely disposed second end, a radius limiting portion disposed at the first end of the retention portion, and a side portion disposed at the second end of the retention portion. The retention portion, the radius limiting portion, and the side portion cooperatively define a passageway for optical fiber routing.

The method further includes the steps of inserting a fiber optic cable through a cable entry opening in the housing of the fiber access terminal. Optical fibers of the fiber optic cable are routed loosely through the passageway of the bend radius limiter. Connectorized ends of the optical fibers are connected to fiber optic adapters that are mounted to the housing.

Another aspect of the present disclosure relates to a fiber access terminal assembly having a housing enclosing an interior region of the housing, where the interior region includes a slack storage area. A plurality of fiber optic adapters are mounted to the housing. The fiber optic adapters include an inner port that is accessible from the interior region of the housing and an outer port that is accessible from an exterior of the housing. A fiber optic cable, which includes a plurality of optical fibers, enters/exits the interior region of the housing through a cable entry opening defined by the housing. At least one bend radius limiter is mounted to the slack storage area of the housing. The bend radius limiter defines a passageway and includes a radius limiting portion having a radius R. A plurality of connectorized ends are mounted to ends of the optical fibers. The connectorized ends are routed through the passageway of the bend radius limiter in the interior region of the housing and inserted within the inner ports of the fiber optic adapters. The optical fibers define a radius R₂ that is at least two times greater than the radius R defined by the bend radius limiter.

A variety of additional aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective view of a fiber access terminal having features that are examples of inventive aspects in accordance with the principles of the present disclosure.

FIG. 2 is a perspective view of an exterior side of a housing of the fiber access terminal of FIG. 1.

FIG. 3 is a perspective view of an interior side of the housing of FIG. 2.

FIG. 4 is a perspective view of the interior side of the housing of FIG. 2.

FIG. 5 is an exploded perspective view of a fiber optic adapter suitable for use with the fiber access terminal of FIG. 1.

FIG. 6 is a cross sectional view of the fiber optic adapter of FIG. 5.

FIG. 7 is a perspective view of a bend radius limiter suitable for use with the fiber access terminal of FIG. 1.

FIG. 8 is a side view of the bend radius limiter of FIG. 7.

FIG. 9 is an enlarged, fragmented, bottom view of the bend radius limiter of FIG. 7.

FIG. 10 is a an exploded perspective view of a housing having features that are examples of inventive aspects in accordance with the principles of the present disclosure.

FIG. 11 is a perspective view of a front side of a cover of the fiber access terminal of FIG. 1.

FIG. 12 is a perspective view of a back side of the cover of FIG. 11.

FIG. 13 is a cable routing scheme for the fiber access terminal of FIG. 1.

FIG. 14 is a cable routing scheme for the fiber access terminal of FIG. 1.

FIG. 15 is a cable routing scheme for an alternate embodiment of a fiber access terminal.

FIG. 16 is an exploded view of a fiber access terminal having features that are examples of inventive aspects in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

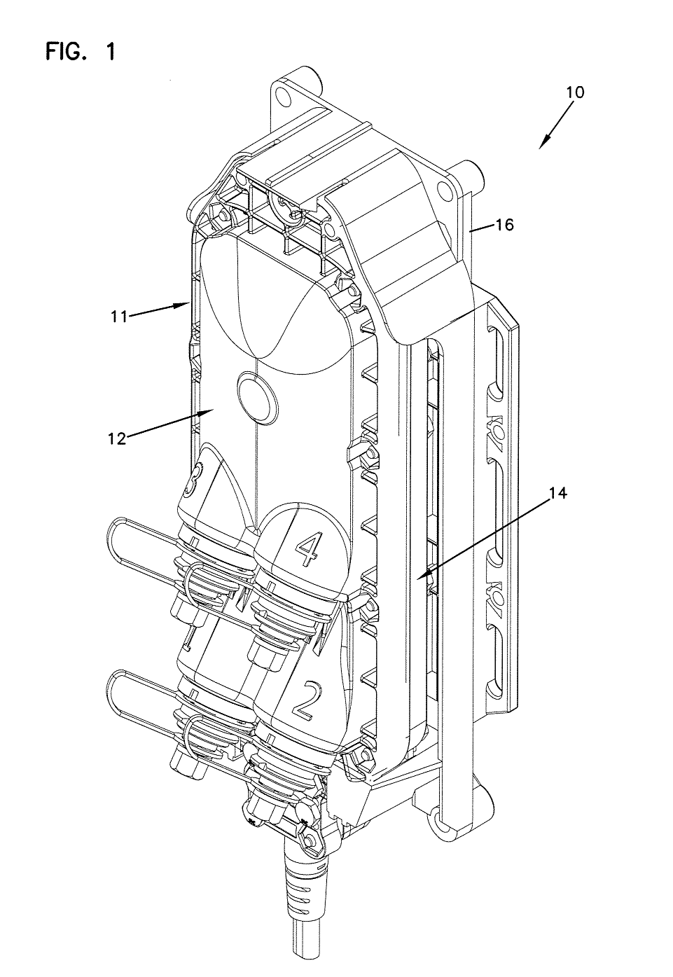

Referring now to FIGS. 1-3, a fiber access terminal, generally designated 10, is shown. The fiber access terminal 10 includes a housing, generally designated 11, having a front housing piece, generally designated 12, and a rear housing piece, generally designated 14. In the embodiment of FIG. 1, the housing 11 is mounted in a bracket 16. As the housing 11 of the fiber access terminal 10 has been described in detail in U.S. patent application Ser. No. 11/075,847 entitled “Fiber access terminal”, which is hereby incorporated by reference in its entirety, the housing 11 will only be briefly described herein.

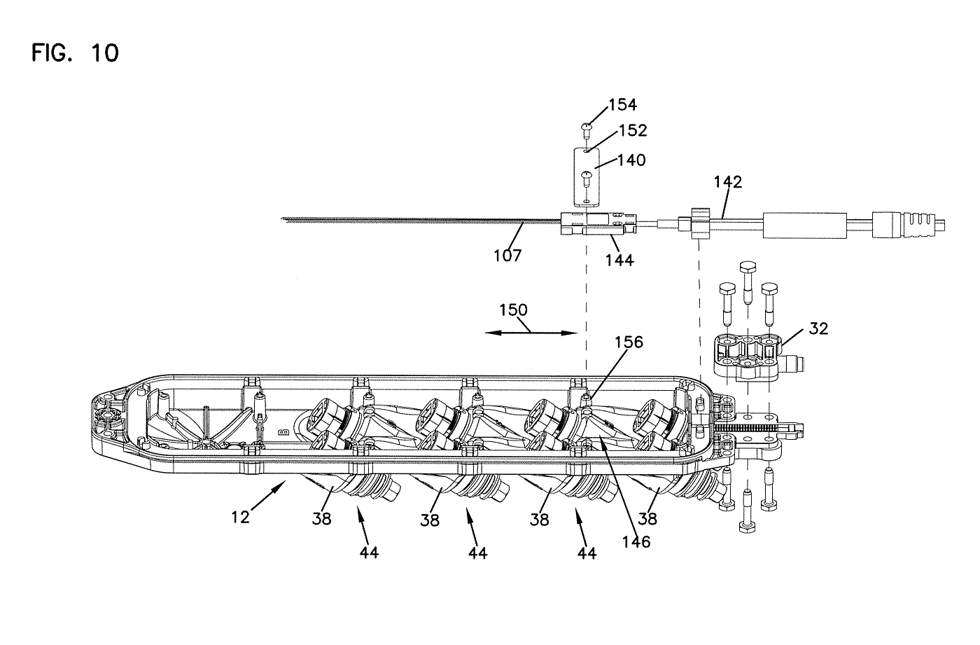

The front housing piece 12 of the housing 11 includes a top, generally designated 18, and a base, generally designated 20. At the top 18 of the front housing piece 12 is a tab 22. The tab 22 defines a tab opening 24. The tab 22 is multifunctional in that it can be used for mounting the fiber access terminal 10 and/or for pulling the fiber access terminal 10 through a conduit to a location for connection to a customer drop cable. The base 20 of the front housing piece 12 defines a cable entry opening 26 that is flanked by a pair of lower tabs 28, which extend from the base 20. Each lower tab 28 defines a fastener opening 30 for mounting a cable clamp 32 (shown in FIG. 10).

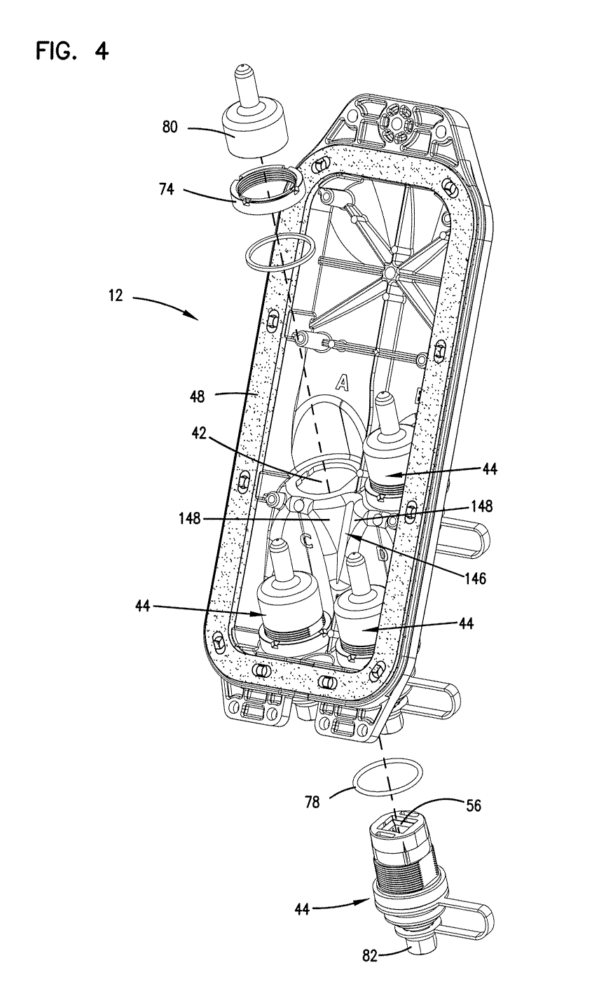

The front housing piece 12 includes an exterior side 34 and an interior side 36. The exterior side 34 of the front housing piece 12 includes a plurality of angled mounting projections 38 with each angled mounting projection 38 having a mounting surface 40. Each of the mounting surfaces 40 are angled toward the base 20 of the front housing piece 12. Disposed in each mounting surface 40 is an opening 42 for receiving a fiber optic adapter 44 (shown in FIGS. 4-6), which will be described in greater detail subsequently.

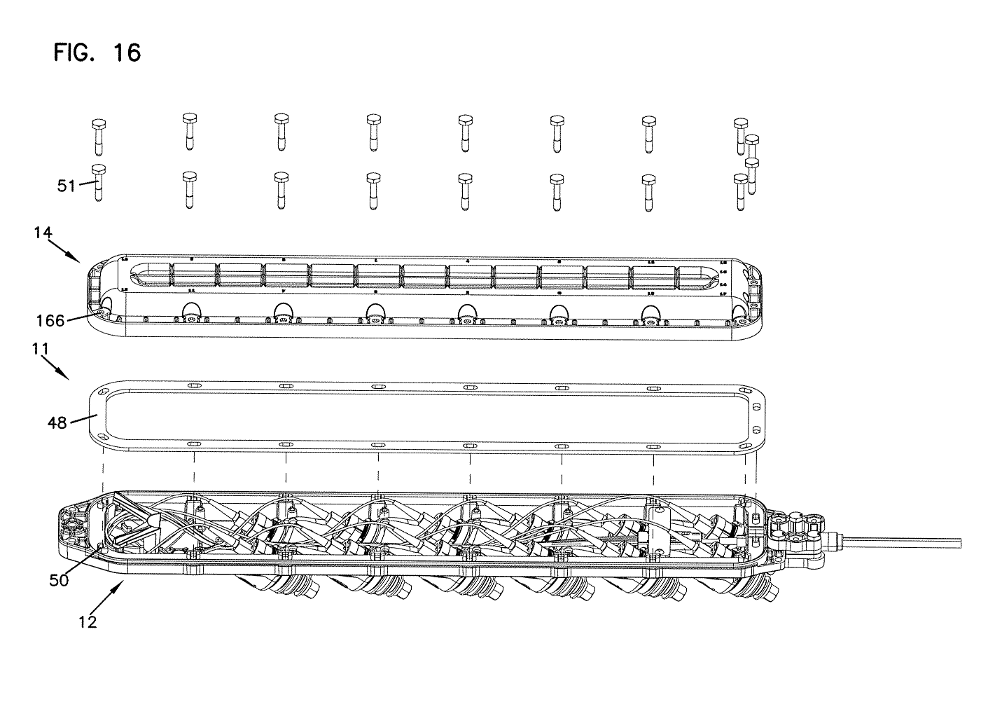

Referring now to FIG. 3, the interior side 36 of the front housing piece 12 forms a portion of an interior region 45 defined by the housing 11 when the rear housing piece 14 is assembled to the front housing piece 12. About a perimeter of the interior side 36 is a recess 46 for receiving a seal 48 (shown in FIG. 4). It is desirable that the fiber access terminal 10 be configured to withstand weather extremes and environmental exposure that may occur from being mounted below ground level, in a damp environment, or in any other outside mounting location. The use of the seal 48 may provide improved resistance to water or other contaminant intrusion that might be caused by exposure to multiple freeze-thaw cycles. A plurality of fastener openings 50 are positioned about the same perimeter extending through the seal 48. Fasteners 51 (shown in FIG. 16), such as screws, bolts, etc., may be extended through the fastener openings 50 to secure the rear housing piece 14 to the front housing piece 12.

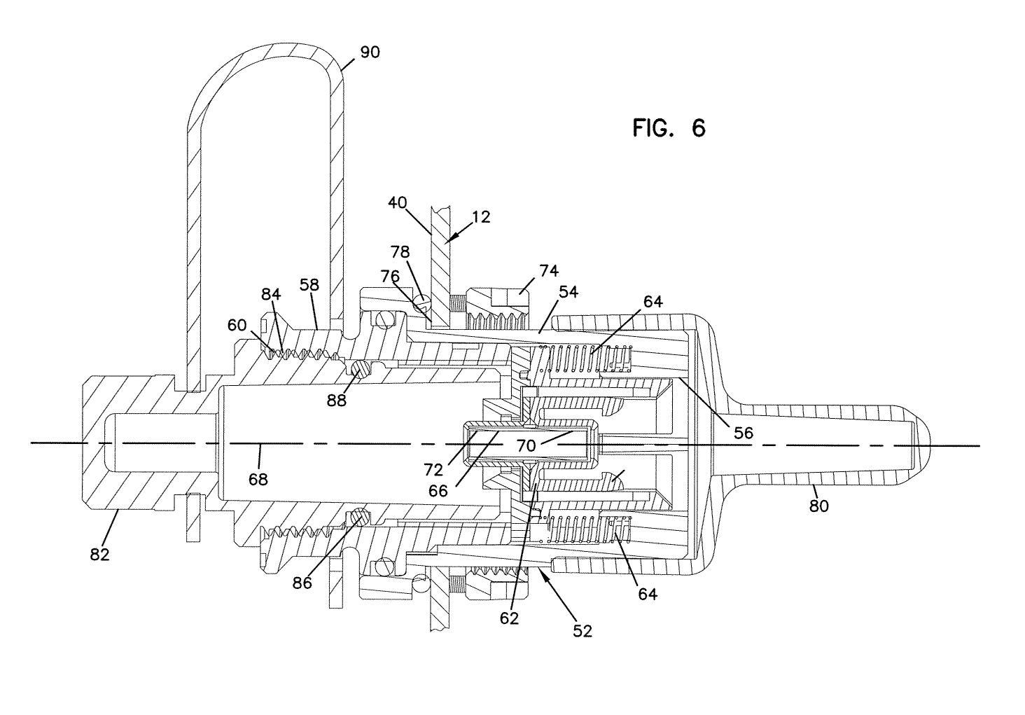

Referring now to FIGS. 4-6, the fiber optic adapter 44 will be briefly described. In FIG. 4, the front housing piece 12 with three fiber optic adapters 44 positioned within the openings 42 and extending from the interior side 36 to the exterior side 34 is shown. A fourth fiber optic adapter 44 is shown exploded from its position within the remaining opening 42. The fiber optic adapter 44 includes a main housing 52 having a first piece 54 that defines an inner port 56 of the fiber optic adapter 44 and a second piece 58 that defines an outer port 60 of the fiber optic adapter 44. The first and second pieces 54, 58 can be interconnected by a snap-fit connection or press-fit to form the main housing 52. A split sleeve housing 62 mounts within the interior of the main housing 52. Springs 64 bias the split sleeve housing 62 toward the outer port 60 and allow the split sleeve housing 62 to float within the interior of the main housing 52. As shown in FIG. 6, the split sleeve housing 62 houses a standard split sleeve 66 that is coaxially aligned with a center axis 68 of the fiber optic adapter 44. The split sleeve 66 includes a first end 70 that faces toward the inner port 56 of the fiber optic adapter 44 and a second end 72 that faces toward the outer port 60 of the fiber optic adapter 44. The fiber optic adapter 44 mounts within one of the openings 42 in the mounting surface 40 of the front housing piece 12 such that the inner port 56 is accessible from the interior side 36 of the front housing piece 12 and the outer port 60 is accessible from the exterior side 34 of the front housing piece 12. The fiber optic adapter 44 is retained within the opening 42 by a retention nut 74 threaded on exterior threads defined by the first piece 54 of the main housing 52. When the retention nut 74 is threaded into place, the corresponding mounting surface 40 of the mounting projection 38 is captured between the retention nut 74 and a shoulder 76 of the main housing 52. A sealing member 78 is compressed between the main housing 52 and the mounting surface 40 to provide an environmental seal about the opening 42.

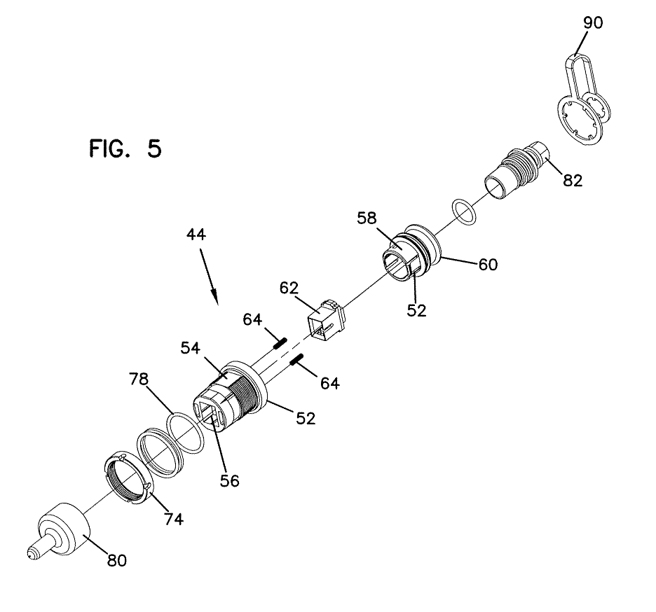

As shown in FIG. 5, a dust cap 80 is shown covering the inner port 56 of the fiber optic adapter 44 and a plug 82 is shown mounted within the outer port 60 of the fiber optic adapter 44. The plug 82 is threaded within internal threads 84 defined within the outer port 60. The plug 82 also includes a sealing member 86 (e.g., an O-ring) that engages a sealing surface 88 within the outer port 60 to provide an environmental seal between the main housing 52 and the plug 82. A strap 90 secures the plug 82 to the main housing 52 to prevent the plug from being misplaced when removed from the outer port 60.

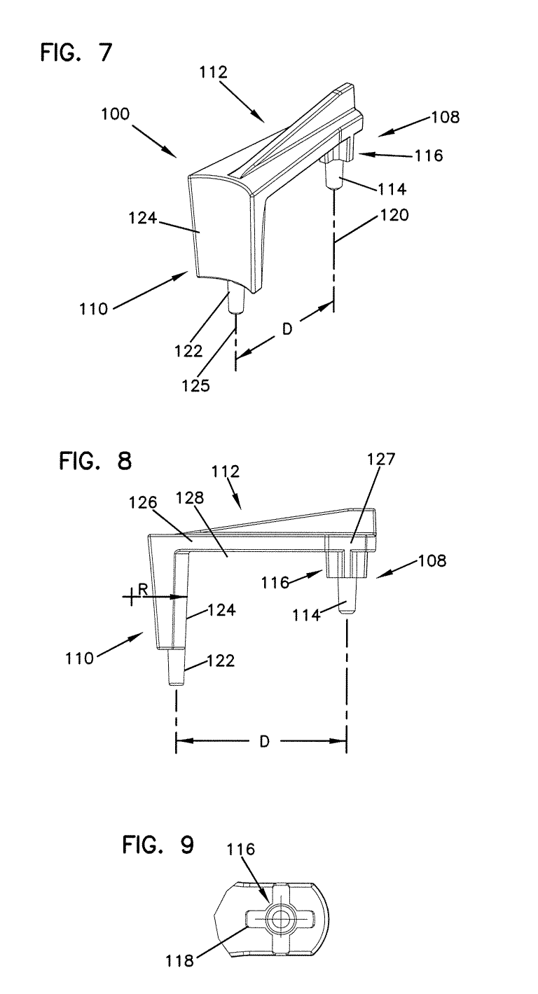

Referring now to FIG. 3, the interior side 36 of the front housing piece 12 includes a connection area 92 and a slack storage area 94. The connection area 92 is disposed behind the angled mounting projections 38 of the exterior side 34 of the front housing piece 12. In the subject embodiment, the slack storage area 94 is disposed adjacent to the connection area 92. The slack storage area 94 includes at least one mount 96 disposed on the interior side 36 of the front housing piece 12. The mount 96 defines a mount opening 98 that is sized to receive a bend radius limiter, generally designated 100 (shown in FIGS. 7-9). In the subject embodiment, the slack storage area 94 further includes a plurality of supporting ribs 102 that outwardly radiate from a location 104 disposed along a plane 106 (shown as a dashed line in FIG. 3) that extends from the base 20 to the top 18 of the front housing piece 12 and symmetrically bisects the housing 11.

Referring now to FIGS. 7-9, the bend radius limiter 100 will be described. The bend radius limiter 100 has a dual purpose in the fiber access terminal 10. The bend radius limiter 100 provides protection from damage due to bending of optical fibers 107 routed in the interior region 45 of the fiber access terminal 10 and aids in the retention of the optical fibers 107 routed in the interior region 45. The bend radius limiter 100 includes a side portion, generally designated 108, a radius limiter portion, generally designated 110, and a retention portion 112. The side portion 108 includes an end portion 114 and a support portion, generally designated 116. In the subject embodiment, the end portion 114 is adapted to fit within the mount opening 98 of the mount 96. The end portion 114 of the side portion 108 is generally cylindrical and tapered in order to aid in the insertion of the end portion 114 into the mount opening 98. The support portion 116 is disposed adjacent to the end portion 114 and includes a plurality of support tabs 118 (best shown in FIG. 9) that extend radially outward from a central axis 120 of the side portion 108. In the subject embodiment, and by example only, there are four support tabs 118 disposed around the central axis 120 in 90 degree increments. The support tabs 118 serve as a positive stop for the end portion 114 when the end portion 114 is inserted into the mount opening 98 of the mount 96.

The radius limiter portion 110 includes an end section 122 and a radius portion 124. In the subject embodiment, the end section 122 is generally cylindrical and extends outwardly from the radius portion 124 along a center axis 125. With the side portion 108 disposed in the mount opening 98 in the interior side 36 of the front housing piece 12, the end section 122 is disposed between adjacent supporting ribs 102 in the interior side 36 of the front housing piece 12. The end section 122, therefore, limits the rotation of the bend radius limiter 100 about the central axis 120 of the side portion 108 by abutting one of the adjacent supporting ribs 102. The radius portion 124 is arcuate in shape and has a radius R. The radius R of the radius portion 124 is sized such that the radius R is greater than a minimum bend radius of the optical fiber 107. In the subject embodiment, the radius R is greater than or equal to three-eighths (0.375) of an inch.

The retention portion 112 includes a first end portion 126 and an oppositely disposed second end portion 127. The radius limiter portion 110 is disposed at the first end portion 126 of the retention portion 112 while the side portion 108 is disposed at the second end portion 127. In the subject embodiment, the central axis 120 of the side portion 108 and a center axis 125 of the radius limiter portion 110 are generally parallel and separated by a distance D. In one embodiment, the distance D is approximately 1.2 inches. The retention portion 112 spans the distance D and connects the support portion 116 of the side portion 108 and the radius portion 124 of the radius limiter portion 110. In the subject embodiment, the retention portion 112 is disposed generally perpendicular to both the central axis 120 of the side portion 108 and the center axis 125 of the radius limiter portion 110. The side portion 108, the radius limiter portion 110, and the retention portion 112 define a passageway 128, the purpose of which will be described subsequently.

Referring now to FIG. 10, a fan-out retention member 140 will be described. A fiber optic cable 142 may include more than one optical fiber 107. In that situation, a fan-out 144 is used to fan-out/spread-apart the optical fibers 107 of the fiber optic cable 142. The fan-out 144 is disposed in a fan-out channel, generally designated 146, in the interior region 45 of the fiber access terminal 10. The fan-out channel 146 includes sidewalls 148 (shown in FIG. 4). The fan-out retention member 140 retains the fan-out 144 in the fan-out channel 146, the sidewalls 148 of which restrict the lateral movement of the fan-out 144. The fan-out retention member 140, however, allows for some movement of the fan-out 144 in a direction 150 (shown as an arrow in FIG. 10) along the plane 106 (shown as a dashed line in FIG. 3), which extends from the base 20 to the top 18 of the front housing piece 12 and symmetrically bisects the housing 11. This allowance of movement in the direction 150 provides protection against tensile and compressive forces acting on the fiber optic cable 142 due to the thermal expansion and contraction of the fiber optic cable 142. The fan-out retention member 140 is a flexible strip of material (e.g., plastic, etc.) having a mounting opening 152 disposed on either side of the fan-out retention member 140. Fasteners 154 are inserted through the mounting openings 152 and are engaged to fan-out mounts 156 disposed on the interior side 36 of the front housing piece 12.

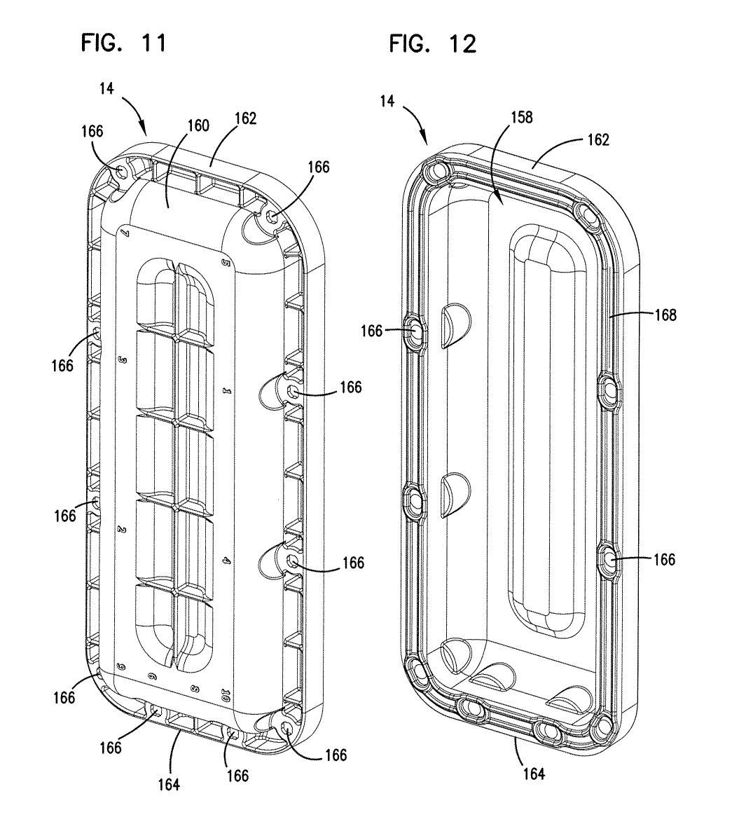

Referring now to FIGS. 11 and 12, the rear housing piece 14 includes a front side 158, a back side 160, a top side 162 and a base side 164. A plurality of fastener openings 166 are positioned about a perimeter of the rear housing piece 14 to correspond with the plurality of fastener openings 50 in the front housing piece 12. The front side 158 of the rear housing piece 14 cooperates with the interior side 36 of the front housing piece 12 to form the interior region 45. A seal surface 168 is disposed on the front side 158 along the perimeter of the rear housing piece 14. The seal surface 168 corresponds to the location of the recess 46 in the front housing piece 12.

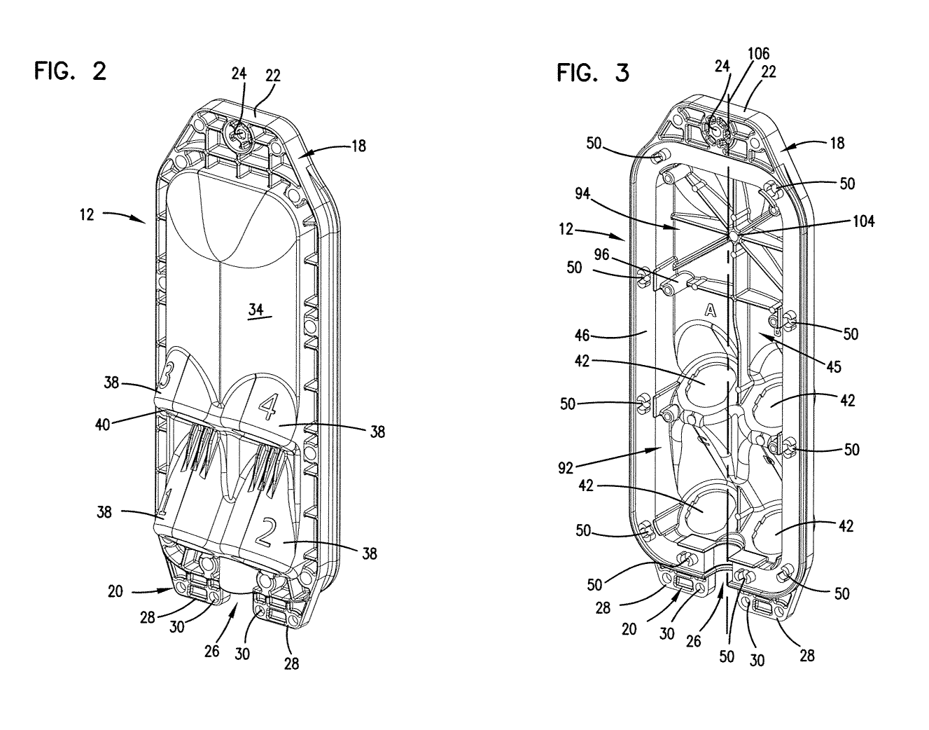

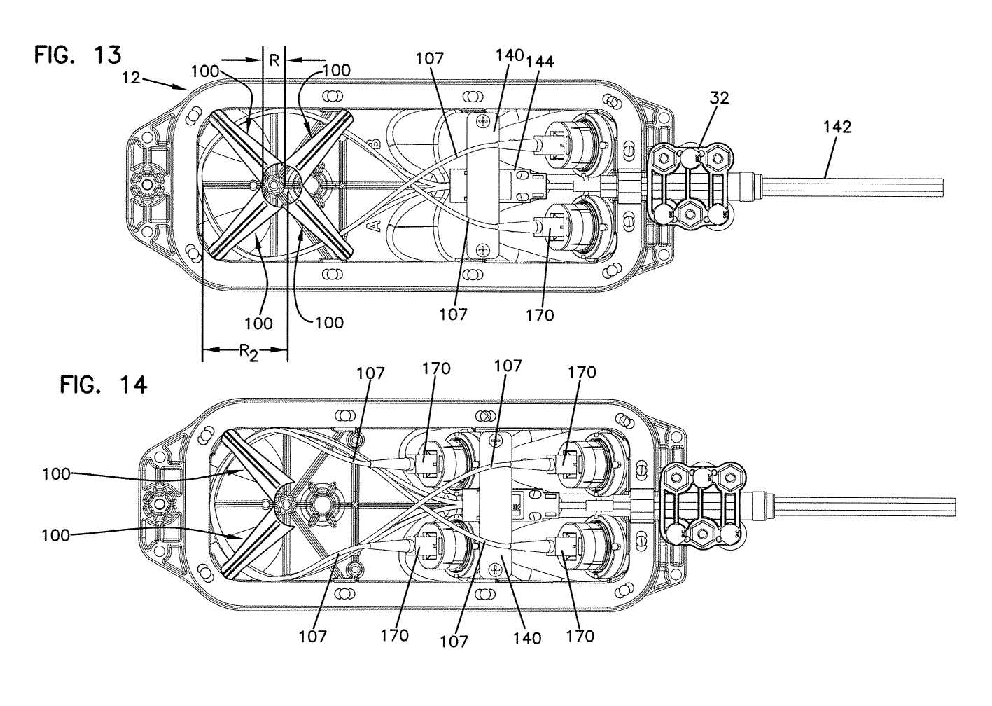

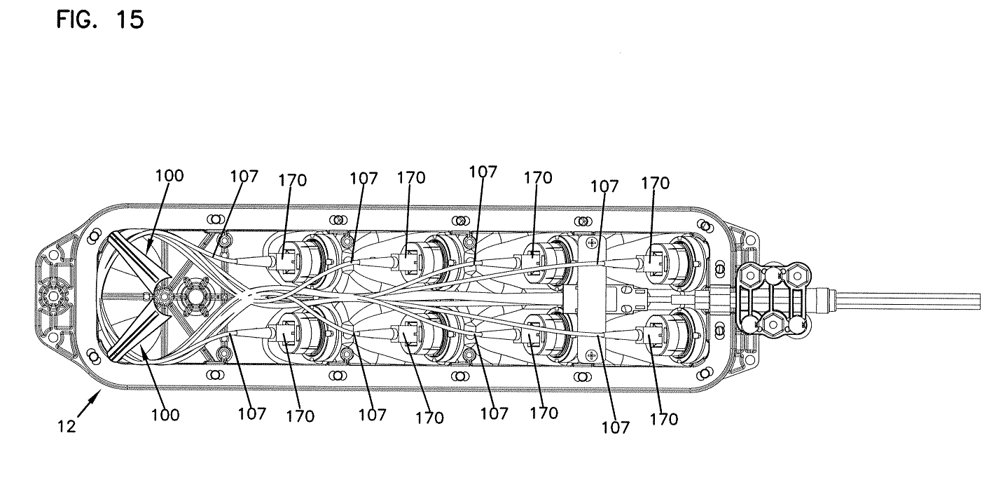

Referring now to FIGS. 13 and 14, cable routing schemes are illustrated. The fiber optic cable 142 enters the front housing piece 12 through the cable entry opening 26 (best shown in FIGS. 2 and 3) and is retained in position by the cable clamp 32. The fiber optic cable 142 enters the fan-out 144 where the individual optical fibers 107 are fanned-out or spread-apart from the fiber optic cable 142. The fan-out 144 is retained in the fan-out channel 146 by the fan-out retention member 140, which is fastened to the plurality of fan-out mounts 156 disposed on the interior side 36 of the front housing piece 12. As previously stated, the fan-out retention member 140 restricts movement in the lateral direction but allows some movement in the direction 150.

At least one bend radius limiter 100 is installed in the interior region 45 of the fiber access terminal 10. In FIGS. 13 and 14, four bend radius limiters 100 and two bend radius limiters 100 are installed, respectively. The optical fibers 107 having connectorized ends 170 are loosely passed through the passageways 128 of the bend radius limiters 100, which are mounted to the mounts 96 in the front housing piece 12. The term “loosely” as used in the present disclosure and the appended claims shall be understood to mean optical fiber 107 that is initially slack in the passageway 128 and not initially taut against the radius limiter portion 110 of the bend radius limiter 100. As shown in the cable routing schemes in FIGS. 13 and 14, in a preferred embodiment, the optical fibers 107 are not coiled around the bend radius limiters 100 but rather are only passed through the passageways 128 of the bend radius limiters 100 one time. Therefore, the greater the distance D between the side portion 108 and the radius limiter portion 110 of the bend radius limiter 100, the greater the length of optical fiber 107 that can be stored in the slack storage area.

In the embodiment in FIG. 13, the cable routing scheme for optical fibers 107 in the fiber access terminal 10 having two fiber optic adapters 44 is shown. One of the optical fibers 107 is loosely passed through the passageways 128 in the clockwise direction while the other optical fiber 107 is loosely passed through the passageways 128 in the counterclockwise direction. In the subject embodiment, the passageway 128 of the bend radius limiter 100 aids in the retention of the optical fibers 107 in the interior region 45 of the fiber access terminal 10 by providing a path that is enclosed by the side portion 108, the radius limiter portion 110, the retention portion 112 and the interior side 36 of the front housing piece 12.

In the embodiment of FIG. 14, the cable routing scheme for optical fibers 107 in the fiber access terminal 10 having four fiber optic adapters 44 is shown. In this embodiment, two of the optical fibers 107 are loosely passed through the passageways 128 in the clockwise direction while the remaining two optical fibers 107 are loosely passed through the passageways 128 in the counterclockwise direction.

In the embodiment of FIG. 15, a cable routing scheme for optical fibers 107 in an alternate embodiment of a fiber access terminal 10 having eight fiber optic adapters 44 is shown. In this embodiment, four of the optical fibers 107 are loosely passed through the passageways 128 in the clockwise direction while the remaining four optical fibers 107 are passed through the passageways 128 in the counterclockwise direction.

With the optical fibers 107 disposed in the passageways 128 of the bend radius limiters 100, the connectorized ends 170 of the optical fibers 107 are then engaged with the inner ports 56 of the fiber optic adapters 44. Referring now to FIG. 16, with the connectorized ends 170 of the optical fibers 107 engaged with the inner ports 56 of the fiber optic adapters 44 and the seal 48 properly seated in the recess 46 in the interior side 36 of the housing, the cover 14 is fastened to the front housing piece 12 by the fasteners 51 that are inserted through the fastener openings 155 in the rear housing piece 14 and engaged with the fastener openings 50 in the front housing piece 12.

The use of the bend radius limiter 100 in the fiber access terminal 10 allows for the connectorized end 170 of the optical fiber 107 to be polished or cleaned without having to remove the rear housing piece 14 from the fiber access terminal 10. With the fiber access terminal 10 assembled as described above, the plug 82 is removed from the outer port 60 of one of the fiber optic adapters 44. The second piece 58 of the main housing 52 of the fiber optic adapter 44 is then disconnected from the first piece 54. By disconnecting the second piece 58 of the fiber optic adapter 44 from the first piece 54, the split sleeve housing 62, which is in connected engagement with the connectorized end 170 of the optical fiber 107, is pulled out of the outer port 60 of the fiber optic adapter 44. The connectorized end 170 is then disconnected from the split sleeve housing 62 and polished or cleaned.

The bend radius limiter 100 allows for the connectorized end 170 of the optical fiber 107 to be pulled out of the outer port 60 until the optical fiber 107 is taut without damage to the optical fiber 107 resulting from bending. As the radius R defined by bend radius limiter 100 is substantially smaller than the radius R₂ defined by the length of optical fiber 107 within the passageway 128 of the bend radius limiter 100. In one embodiment, the radius R₂ of the optical fiber 107 is at least two times larger than the radius R defined by the bend radius limiter 100. In another embodiment, the radius R₂ of the optical fiber is at least three times larger than the radius R defined by the bend radius limiter 100. This difference in radius R defined by the bend radius limiter 100 and the radius R₂ defined by the optical fiber 107 provides sufficient slack in the optical fiber 107 to allow the connectorized end 170 of the optical fiber 107 to be pulled out of the outer port 60 of the fiber optic adapter 44 for polishing or cleaning the connectorized end 170.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

1. A fiber access terminal assembly comprising:
a housing having a front housing piece and a rear housing piece, wherein the front housing piece includes an interior side and an exterior side and the rear housing piece is selectively mounted to the interior side of the front housing piece;
a slack storage area defined by the interior side of the front housing piece; and
at least one bend radius limiter mounted to the slack storage area of the front housing piece, the bend radius limiter having:
a retention portion with a first end and an oppositely disposed second end;
a radius limiting portion disposed at the first end of the retention portion;
a side portion disposed at the second end of the retention portion; the retention portion, the radius limiting portion, and the side portion cooperatively defining a passageway for optical fiber routing, wherein the retention portion, the radius limiting portion, and the side portion cooperate with the interior side of the front housing piece to enclose the passageway.

2. (canceled)

3. A fiber access terminal assembly as claimed in claim 1, wherein the side portion is mounted to the interior side of the front housing piece.

4. A fiber access terminal assembly as claimed in claim 1, wherein the side portion defines a central axis that extends longitudinally through the side portion and the radius limiting portion defines a center axis that extends longitudinally through the radius limiting portion, wherein the central axis and the center axis are generally parallel.

5. A fiber access terminal assembly as claimed in claim 4, wherein the retention portion is generally perpendicular to the central axis through the side portion and the center axis through the radius limiting portion.

6. A fiber access terminal assembly as claimed in claim 1, further comprising a plurality of fiber optic adapters mounted to a mounting surface on the exterior side of the front housing piece.

7. A fiber access terminal assembly as claimed in claim 6, wherein the exterior side of the front housing piece includes mounting projections having the mounting surfaces on which are mounted the fiber optic adapters.

8. A fiber access terminal assembly as claimed in claim 1, further comprising a fan-out device for fanning-out a plurality of optical fibers from a fiber optic cable.

9. A fiber access terminal assembly as claimed in claim 8, further comprising a fan-out retention member mounted to the interior side of the front housing piece for retention of the fan-out device.

10. A fiber access terminal assembly as claimed in claim 9, wherein the fan-out retention member is a flexible strip of material.

11. A fiber access terminal assembly as claimed in claim 9, wherein the fan-out device is retained in a fan-out channel in the interior side of the front housing piece.

12. A fiber access terminal assembly as claimed in claim 1, wherein there are two bend radius limiters mounted in the slack storage area.

13. A fiber access terminal assembly as claimed in claim 1, wherein there are four bend radius limiters mounted in the slack storage area.

14. A method of routing an optical fiber through a fiber access terminal comprising the steps of
providing a fiber access terminal having:
a housing having a front housing piece and a rear housing, wherein the front housing piece includes an interior side and an exterior side and the rear housing piece is selectively mounted to the interior side of the front housing piece;
a slack storage area defined by the interior side of the front housing piece;
at least one bend radius limiter mounted to the slack storage area of the front housing piece, the bend radius limiter having a retention portion with a first end and an oppositely disposed second end, a radius limiting portion disposed at the first end of the retention portion, and a side portion disposed at the second end of the retention portion, the retention portion, the radius limiting portion, and the side portion cooperatively defining a passageway for optical fiber routing, wherein the retention portion, the radius limiting portion, and the side portion cooperate with the interior side of the front housing piece to enclose the passageway;
inserting a fiber optic cable through a cable entry opening in the housing;
routing optical fibers of the fiber optic cable loosely through the passageway of the bend radius limiter; and
connecting connectorized ends of the optical fibers to fiber optic adapters mounted to the housing.

15. (canceled)

16. A method of routing an optical fiber through a fiber access terminal as claimed in claim 14, wherein the side portion is mounted to the interior side of the front housing piece.

17. A method of routing an optical fiber through a fiber access terminal as claimed in claim 14, further comprising the step of mounting a fan-out device in the housing with a fan-out retention member.

18. A method of routing an optical fiber through a fiber access terminal as claimed in claim 17, wherein the fan-out retention member is a flexible strip of material.

19. A method of routing an optical fiber through a fiber access terminal as claimed in claim 17, wherein the fan-out device is retained in a fan-out channel in the interior side of the front housing piece.

20. A fiber access terminal assembly comprising:
a housing enclosing an interior region of the housing, wherein the interior region includes a slack storage area;
a plurality of fiber optic adapters mounted to the housing, the fiber optic adapters including inner ports that are accessible from the interior region of the housing and outer ports that are accessible from an exterior of the housing;
a fiber optic cable that enters/exits the interior region of the housing through a cable entry opening defined by the housing, wherein the fiber optic cable includes a plurality of optical fibers;
at least one bend radius limiter mounted to the slack storage area of the housing, wherein the bend radius limiter defines a passageway and includes a radius limiting portion having a radius R;
a plurality of connectorized ends mounted to ends of the optical fibers, the connectorized ends being routed through the passageway of the bend radius limiter in the interior region of the housing and inserted within the inner ports of the fiber optic adapters, wherein a portion of the optical fibers disposed in the passageway defines a radius R₂ that is at least two times greater than the radius R defined by the bend radius limiter.

21. A fiber access terminal assembly as claimed in claim 20, wherein the bend radius limiter includes a retention portion with a first end and an oppositely disposed second end, a radius limiting portion disposed at the first end of the retention portion, and a side portion disposed at the second end of the retention portion.

22. A fiber access terminal assembly as claimed in claim 21, wherein the radius R2 defined by the portion of the optical fibers disposed in the passageway is at least three times greater than the radius R defined by the bend radius limiter.
